(19) United States
(12) Patent Application Publication
(10) Pub. No.: US 2002/0194047 A1
(43) Pub. Date: Dec. 19, 2002

(54) End-to-end service delivery (post-sale) process

(75) Inventors: Jerry Edinger, Parkesburg, PA (US); Harry Cook, Raleigh, NC (US); Keith Dahigren, Rochester, MN (US); Colin Greaves, Maidenhead (GB); Kazuhiro Hayashi, Yachiyo-shi (JP); William Kamszik, Cary, NC (US); David Leder, Cary, NC (US); Eric Partington, Windsor (GB); Noel W. Ryan, Bonnet Bay (AU); Charles A. Simonin JR., Colleyville, TX (US); James Bell, Marietta, GA (US)

Correspondence Address: C. Lamont Whitham, McGuireWoods, LLP, Suite 1800, 1750 Tysons, Blvd., McLean, VA, 22102, US

(73) Assignee: INTERNATIONAL BUSINESS MACHINES CORPORATION, ARMONK, NY

(21) Appl. No.: 09/859,994

(22) Filed: May 17, 2001

(51) Int. Cl. G06F 17/60

(52) U.S. Cl. 705/9

(57) ABSTRACT

A customer support management system and method resolves both hardware and software problems using a single business model. The system and method is based on interaction between a hierarchy of corporate personnel/consultants and a customer support management system which tracks the evolution of customer support requests from inception to completion. The customer support management system includes a number of software tools including an automated scheduler connected to a database system for storing at least one of customer, product, service provider, and routing information. When a customer experiences a problem with a hardware or software product, the customer sends a support request to the manufacturer. Through an interactive process, first, between the manufacturer and the customer and, then, between system personnel, the system tools are utilized to locate a service provider anywhere in the world in order to provide on-site support for satisfying the customer support request.

### BACKGROUND OF THE INVENTION

1. Field of the Invention

This invention generally relates to customer support management, and more particularly to an end-to-end system and method which employs a single business model to process customer support requests for products which, for example, may include both computer hardware and software.

2. Description of the Related Art

Conventional methods for providing customer support differ for hardware and software. Software problems are handled using various processes depending on the geographical location of the customer, the nature of the problem, and the resources available. As an example, if a customer places a request for software support in the United States, customer information would be gathered and an initial evaluation would be performed to determine if the customer is entitled to receive service. The request would then be routed to a skilled technician who would perform a series of steps to identify the cause or source of the problem. An action plan would then be developed to resolve the problem. In Spain, this process would look different than in the United States, both internally and from the customer's point of view. And in Japan, this process would look different from the processes in Spain and the United States. This disparity in customer service management across geographical boundaries has proven costly and inefficient.

Hardware problems are handled in a different manner. For example, different support tools, personnel, and internal routing procedures are used. Also, conventional hardware support models are very detailed and require substantially more information from the customer before problem determination/source identification can be determined, as compared to the software support model. The disparity in customer service management across product lines, and especially for hardware and software, has also proven costly, not only for customer service providers but also for customers themselves who often are required to wait days if not weeks for an effective solution.

Thus, a significant drawback of conventional customer support systems is that they are not integrated, i.e., there is no one customer support system which is 47 standardized to handle both hardware and software problems. Consequently, customers cannot determine, with certainty, how many problems the support vendors are working on, nor could the status of those problems be determined at any given point in time.

In view of the foregoing considerations, it is therefore evident there is a need for a system and method which uses a single business model to manage customer support requests for both hardware and software products, and moreover one that does so regardless of the geographical location of the customer, the nature of the problem to be solved, or the types of software and hardware product lines that require support. There is also a need to implement such a method in an efficient manner, through interaction between a hierarchy of corporate personnel/consultants and a customer support management system which tracks the evolution of customer support requests from inception to completion. A further need exists to make such a system and method easily accessible to the customer, so that the customer will at all times be informed of the status of the support and the costs incurred.

### SUMMARY OF THE INVENTION

It is one object of the present invention to provide a single business model for managing customer support requests for products which have inherently different technical demands and which therefore have conventionally been handled by different customer service models.

It is another object of the present invention to provide a system and method for managing customer support requests which use the aforementioned business model to resolve customer problems irrespective of the geographical location of the manufacturer's customer base.

It is another object of the present invention to provide a system and method for managing customer support requests which may be implemented worldwide, to thereby enable the manufacturer to create an integrated, global, customer-support system which customers may rely on to obtain fast and efficient support for a full array of products. By accomplishing this object, the manufacturer may create for itself a reputation for quality, which will engender consumer confidence and potentially result in an increase in demand for the manufacturer's products.

It is another object of the present invention to provide a system and method as previously described which uses a network of best-of-class service professionals in a variety of technical fields to thereby meet marketplace needs and provide global services for the manufacturer's products.

It is an object of the present invention to provide a customer support management system and method which employs the same management model for handling both computer hardware and software requests.

It is another object of the present invention to provide a customer support management system and method which communicates with and provides support in the particular language of the customer.

It is another object of the present invention to provide a customer support management system and method which is easily accessible to the customer, so that the customer will at all times be informed of the status of the support and the costs incurred.

The foregoing and other objects of the invention are achieved by providing a customer support management system and method which resolves both hardware and software problems using a single business model. The system and method is based on interaction between a hierarchy of corporate personnel/consultants and a customer support management system which tracks the evolution of customer support requests from inception to completion. The customer support management system includes an automated scheduling software tool connected to a database system for storing at least one of customer information, product information, service provider information, and routing information. When a customer experiences a problem with a hardware or software product, the customer sends a support request to the manufacturer. The request may be sent electronically, by voice, or by mail in any language. If sent by mail, the manufacturer's call center will forward the customer call to a representative who speaks the language of the customer.

Once a call is received, an initial step of creating a record in the database system corresponding to the customer support request is performed using the scheduling software tool. Advantageously, the record is standardized to correspond, in terms of data fields, to both hardware and software service requests. This standardization reduces administrate burdens and streamlines the efficiency of the management process as the customer's case is routed throughout various personnel within the system. If a record already exists for the support request, the call center representative may access this record in the database to provide the customer with status information.

After an interactive exchange between the customer and representative, enough information is gathered to enable a skilled technician to determine a course of action. Routing logic within the system is then used to forward the customer support request record to a remote service delivery agent, who identifies the source of the problem the customer is experiencing and then develops an action plan for resolving the problem. The database records may be updated with information detailing the source of the problem and the action plan.

Process control is then given over to a local service delivery agent who is local (e.g. within a 50 mile radius) of the customer location. The local service delivery agent executes the action plan on-site and then obtains feedback to determine customer satisfaction. If the action plan failed, the database system records are updated and a technical escalation process is implemented to select a higher-level service technician. At each stage of the process, the database system records may be monitored by personnel in the system to determine real-time status of the customer support request, which can then be conveyed to the customer.

Unlike conventional customer support approaches, the system and method of the present invention, thus, employs a single, standardized business model to manage customer requests for software and hardware worldwide. This represents a significant improvement in the art, as conventional customer support models manage hardware and software with different support staff, procedures, and infrastructures. The present invention integrates support for hardware and software products, thereby enhancing customer convenience and the efficiency with which the manufacturer provides customer support.

The benefits that a company will see by deploying the present invention are significant. For example, the number of different internal systems and processes a company must employ to handle customer support requests, from start to finish, would be substantially reduced, and this would therefore translate into improved efficiency and cost savings both to the customer and the company. Also, the data captured inside of the support process would be standardized and automated, therefore reducing administrative burdens. Another benefit is that the customer will, for the first time, be handled one way with respect to hardware and software problems and thus will be able to see all of their support requests in one report instead of multiple reports and or systems.

### BRIEF DESCRIPTION OF THE DRAWINGS

FIG. 1 is a flow diagram showing steps included in a preferred embodiment of the method of the present invention for providing customer support.

FIG. 2 is a flow diagram showing the customer-support request generation, submission, and entitlement steps of the method of the present invention.

FIG. 3 is a flow diagram showing the case creation and routing steps of the method of the present invention.

FIG. 4 is a flow diagram showing steps included in the method of the present invention for delivering customer support

### DESCRIPTION OF THE PREFERRED EMBODIMENTS

The present invention is a customer support management system and method which is preferably implemented as an end-to-end process, in the sense that management is performed from the time a customer request for support is submitted to the time of the request is resolved. The system and method operate in accordance with a management model that is predicated on interaction between a customer-support database management system and a hierarchy of support technicians, information technology specialists, and other personnel who may either be employees of the product manufacturer, contractors/consultants, or both.

To provide ubiquitous appeal, the invention may be configured to have no geographical limitations. This is achieved by connecting the system to one or more networks. This allows personnel to be remotely located in order to provide worldwide customer support management. The invention, therefore, is suitable for use by multi-national corporations, although applications to businesses with more limited geographical customer bases may be implemented.

Structurally, the system of the present invention includes a database architecture which may be a single centralized unit or multiple database units connected, for example, by a storage-area network. The database stores customer information (e.g., addresses, telephone numbers, installed products for hardware and/or software), customer personnel information, and information indicating the locations of the installed products (e.g., what floor, what building, what room, etc.), among others. A more detailed, but by no means comprehensive, listing of the types of customer-specific information stored in the database includes:

Contact Name (First and Last Name)

Customer Problem #

Vendor Problem #

Requester's Name

Organization/Division Name

Site ID or Customer #

Enterprise # or Contract #

Product Type

Product Number (product name, product number)

Serial Number of Processor on which the software is installed

Customer Description of Request

Customer's selectable request type and sub-request type

Customer Problem #

Pin/Password

Operating System.

Customer's Opinion of Severity

Alternate contact full name and phone number

E-mail address

Product Specific Information

Machine Type

Machine Model number

Software Product Identification Number

Product Name

Feature Number

Feature Name

Software Component Identification Number

Routing Information

Queue Name

Queue Number

Support Center Name

Support Center Number

Request Type of Information

Request Number

Description of request

Description of problem

Location support is to be provided

Severity of request

Action Plan Type of Information

Steps that need to be take to resolve the customer's request

Steps that have be performed to solve the customer's requests

Materials needed information

Materials ordered information

Materials Shipped information

Status of Request

Status Codes with time stamps and user who performed the update

Activity Codes with time stamps and user who performed the update

The database of the present invention may be linked to one or more contract management tools or repositories to perform, for example, entitlement verification when a customer has a request. These tools include the Automatic Scheduler and the Global Parts System. The Automated Scheduler is a front-end computer tool which performs data entry, update, and display functions, scheduling, contact support, as well as other functions, and thus generally serves as the graphical user interface between the personnel of the manufacturer and the computer database system. The Automated Scheduler assists in determining the correct individuals required (based on required skills and availability) to perform the support requested by a customer, and by the terms and conditions of the contracts the customer has with the support provider will determine when the support must be delivered to the customer. The Automated Scheduler is preferably one disclosed in any of pending U.S. patent application Ser. Nos. 09/444,333, 09/443,710, and 09/474,951, the contents of which is incorporated by reference herein.

The Global Parts System stores information on materials that may prove necessary in order to satisfy the customer support request. For example, this system stores information on the location(s) of various parts that are currently available, as well as parts numbers, quantities, dimensions, and other specification data. This information will be made accessible to the delivery agent within the system network for purposes of determining the location of materials closest to the customer site. Once this location is determined and the necessary parts have been ordered, the system will perform a tracking function until those parts have been finally disposed of. The tracking function involves storing shipping information for parts, from the time they leave the warehouse to the time they are installed at the customer site. Return of ordered but unused parts may also be tracked. The parts system will also automatically reorder parts in order to maintain minimum stocking levels, and select the most cost effective transportation to meet the terms and conditions of the customer service contract.

By linking the aforementioned tools, the system and method of the present invention will select and then route customer requests to the proper skilled technician, along with the proper materials required to deliver that support in precisely the correct time to meet customer contractual requirements.

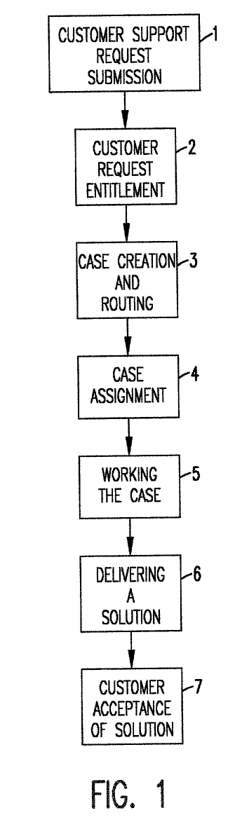

Referring to FIG. 1, in accordance with one embodiment, the customer support management method of the present invention is implemented in accordance with the following steps:

1 Customer Support Request Submission

2 Customer Request Entitlement

3 Case Creation and Routing

4 Case Assignment

5 Working on the Case

6 Delivering a Solution

7 Customer Acceptance of the Solution

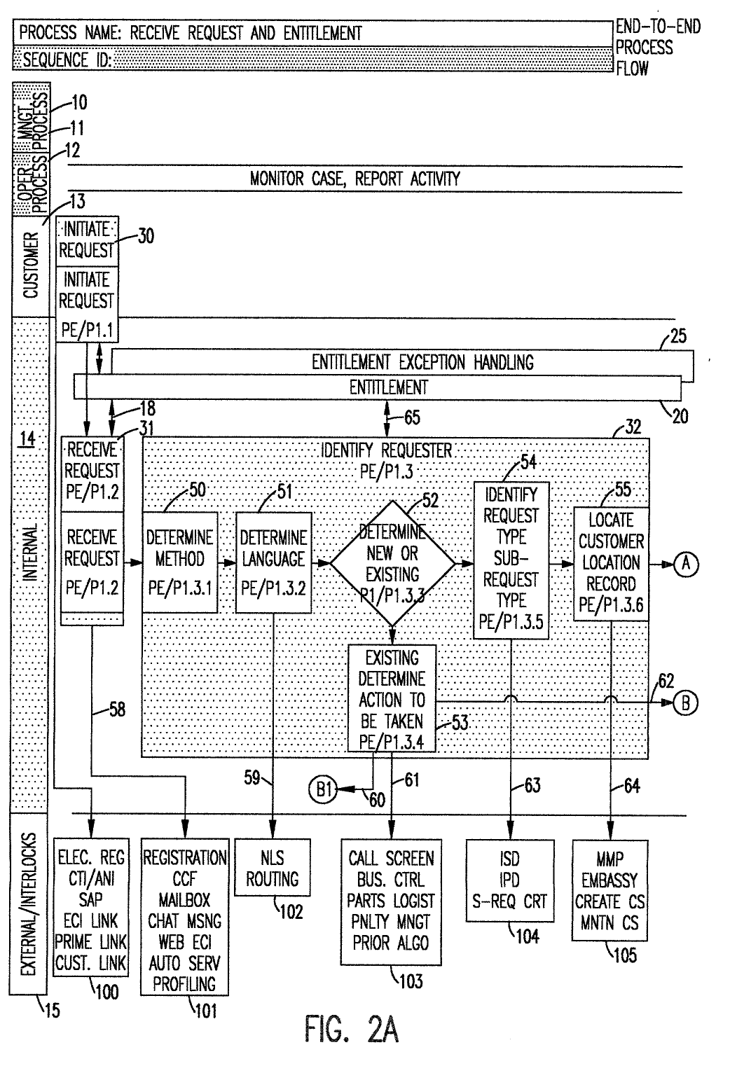

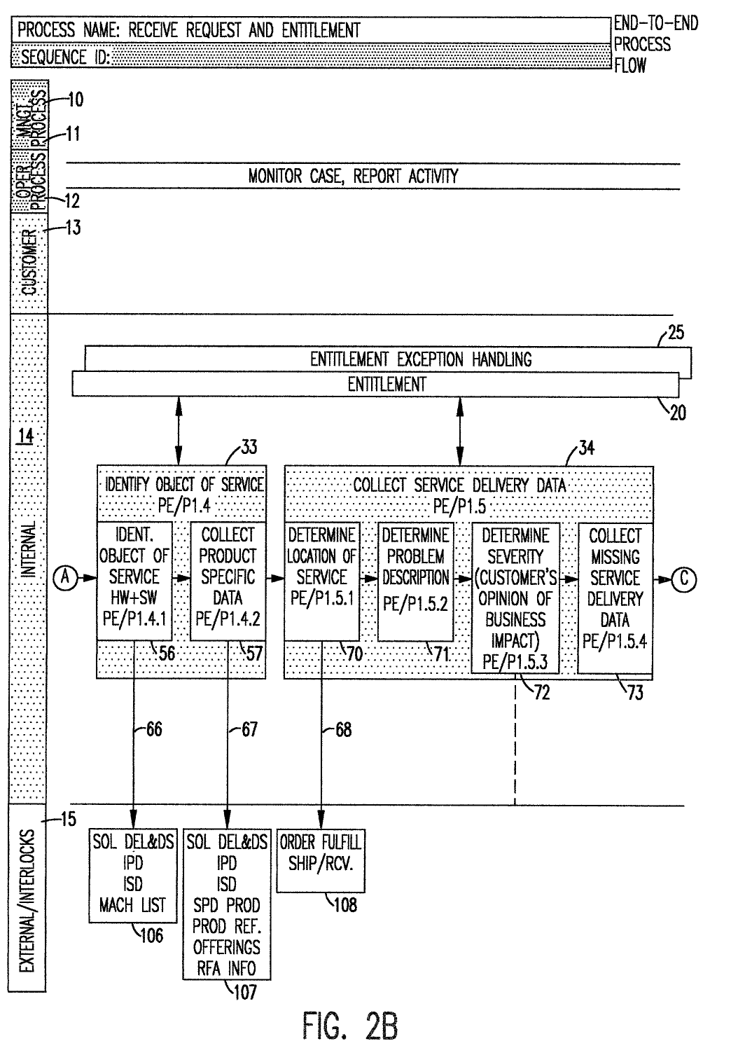

FIGS. 2-4 are flow diagrams showing the functions performed at various stages of the management model embodied within the invention. In these diagrams, an action bar 10 is partitioned into sections which correspond to management functions 11, operational functions 12, customer functions 13, internal functions performed within the management system 14, and external functions and interlocks 15. The management and operational functions correspond to processes which run in parallel with the customer and internal functions. The customer functions are tasks which the customer must perform, often interactively, with system personnel during management of a customer support request. The internal functions correspond to a series of tasks performed by the system in managing the customer support request from start to finish. And, the external functions and interlocks correspond to external processes which may be executed or interlocked with the internal processes in order to satisfy a customer support request.

The flow diagrams also include a number of function boxes which reside in predetermined sections of the action bar. These function boxes include a “Monitor Case, Report Activity” box, an “Entitlement Exception Handling” box, an “Entitlement” box, and a plurality of functional boxes under the Internal and External/Interlock headings. The Monitor Case, Activity Report function box indicates that, at various stages of the method, system personnel may update case records in the database which correspond to customer support requests. This is an especially advantageous feature of the invention because any person in the network may immediately determine and update the status of a customer support request regardless of that person's location.

As a further advantage, the management system may configured to receive requests locally and/or from remote locations. Through use of the Internet, requests may even be received from other parts of the world. System personnel may then select and dispatch a local support technician to answer the request, or the request may be handled remotely such as on-line or by telephone in a language which is understandable by the customer. Other ways of answering a support request will be described.

The functions of the Entitlement, Entitlement Exception Handling, Critical Situation Exception Handling, and other boxes will become apparent from the following discussion.

### Customer Support Request Submission

Referring to FIG. 2, the method of the present invention begins when a customer initiates a request for support 30. The customer may be an end user of the product or a business. Because the system preferably operates using a network, the customer may be remotely located from the site of the manufacturer's representative. This advantageously streamlines the efficiency of handling of the support request by reducing the work load on the manufacturer while simultaneously enhancing customer convenience.

In accordance with a preferred embodiment, the support request is made in connection with a computer-related product. Those skilled in the art can appreciate, however, that the invention may provide support for non-computer-related products such as household appliances, telephone equipment, or any device or system that can be supported over the telephone or via the postal service. For purposes of convenience, the remainder of the discussion will only address the management of support requests for computer hardware and software products using the single business process model described below.

After the support request is initiated, the customer sends the request to a representative of the manufacturer 31, or a business entity with whom the manufacturer has contracted to handle support requests. The support request may be conveyed in one of the following ways:

Electronic, including the Electronic Customer Interface (ECI), Universal Remote Support Facility (URSF), Electronic Customer Call Option (ECCO), E-MAIL, FAX, IBMLINK which is an electronic means for a customer to submit a request for support to IBM, and Interactive Websites.

Voice, including telephony and telephone

Technology interlock, including Customer Telephony Interface (CTI) and Automatic Number Identification (ANI)

Fulfillment (SAP)

Mail (USPS, FEDEX, UPS)

Function Block 101 is an external process which the method of the present invention may interlock with. If a customer submits a request to this process via an electronic means (e.g., ECCO or IBMLINK), the information that is sent will go down line 58 to block 101 to insure that the customer is registered to send the request.

The identity of the manufacturer's representative may vary depending upon the type of request that was sent. For example, if the request was a voice message the representative may be a telephone operator at a call center. If the request was sent by courier, the representative may be an employee in a mail center. If the request was sent electronically, the representative may be a technician in a data center. If desired, the call, mail, and data centers may be located at a common site. Preferably, the data center is operated in conjunction with an interactive website which allows personnel to communicate with customers in delayed or real time. Through the use of web cams and a video-voice link, customers and system personnel may even talk and see one another during the request submission.

Once the support request is submitted, it may be acknowledged by a return communication along with additional information, described in greater detail below. At this point, the representative may access the computer database through the Scheduler tool to make a determination as to entitlement 18 (i.e., whether the customer is entitled to receive support based, for example, on a service contract the customer may have signed) if the customer has provided enough information in the request and the solution to the customer's problem is immediately apparent to the representative. If a determination cannot be immediately made, process flow continues as follows.

### Customer Request Entitlement

Once the initial request has been made, a determination is made as to whether the customer is entitled to receive a solution to the support request. This entitlement step is performed in accordance with function blocks that include Identify Requester 32, Identify Object of Service 33, and Collect Service Delivery Data 34.

### Identify Requester

After a support request is received, the first function to be performed involves determining the identity of the customer who sent the request. In order to answer this question, the following sub-process steps are performed:

| Function Block | Function |
|---|---|
| 50 | Identify method used to communicate request |
| 51 | Identify language used to communicate request |
| 52 | Determine whether request is a new or existing one |
| 53 | If Existing, determine action to be taken |
| 54 | Identify request type/sub-request type |
| 55 | Locate customer record |

Method of Communication.

The method which the customer used to communicate the request will be apparent if the request is sent, for example, by voice or mail. In accordance with a preferred embodiment of the present, the request may be received by Interactive Voice Recognition (IVR)/Computer Telephone Interface (CTI). If the call is received via Interactive Voice Recognition(IVR)/Computer Telephony Interface(CTI), there will be a field “Speaking Language” in the receive request when the phone number is recognized and manually overwritten by the representative if the customer speaking language is different from the language previously defined. A time-stamped activity is then created by the tool.

Language.

In order to determine the language the customer used to communicate the customer support request when the request is communicated electronically, the customer must supply at least one of the following either beforehand or with the request submission:

Web login ID

ECI login ID

Customer number/Customer Master Record ID

E-mail address

Once received, the system will compare the above information against customer profile information in the database to automatically determine the identity and language of the customer.

If the language is one which the call center representative cannot understand, various approaches may be taken to resolve this issue. One approach is to use the aforementioned Interactive Voice Recognition device that will have the customer select the language in which he prefers to speak (e.g., press 1- for English, 2-Spanish, 3-German, 4-Japanese.) When a language selection is made, the call will be routed to an individual who speaks that language. Preferably, the call centers included in the system of the present invention are set up with personnel to support multi-lingual queues.

If the request is sent by voice, the telephone number of the customer may be automatically determined (e.g., using caller ID) and then compared with customer profiles in the database in order to determine identity and language.

If the request is sent by mail or fax, the identity and language of the customer may be determined by the phone number supplied on the fax form that is sent in. If there is not a phone number on the FAX form, a fax will be sent back asking for the telephone number and any other important information required to open a request for the customer. If desired, the customer may indicate directly in the request his identity and language. Alternatively, the customer may provide a customer registration number in the request which can be searched against the computer profiles in the database, either automatically or by the call center representative, to determine the identity and language of the customer.

Function block 51 is connected to block 102 by an arrow 59. Arrow 59 is taken any time a language is not supported by representatives in the call center. This may occur, for example, when the customer calls into a Japanese-speaking call center and selects French support via the IVR. If this occurs, process control shifts to function block 102, which is an external process that determines the location of the French-speaking call center. The information provided by the customer is then automatically forwarded to that call center. The French-speaking call center may be the same Japanese-speaking call center if it is multi-lingual or may be a center in Paris or some place else.

New or Existing Service Request.

Whether the customer request for support is a new or existing request is determined, for example, by the customer telling the call agent this information. Alternatively, this information may be entered into the IVR in the form of an existing request number which may be matched with the database files. If the request is an existing request, the following steps may be executed:

Existing Request

Obtain service request ID from customer. (DIALOG)

Does customer have service request ID? (DIALOG):

YES: Display the enter service request using service request ID provided by customer ID into tool.

GO TO “New Process”

NO: (Customer does not have service request ID): GO TO “Locate Customer Location Record” Process

In the above steps, the call center representative enters the service request ID into the Scheduler tool in order to access the existing system record corresponding to the customer request. If the request is not an existing one, a new system record may be created by the call center representative which corresponds to the request.

Arrows 60, 61, and 62 lead from function box 53. Whether one or more of these paths are taken is determined by logic within the management system as applied to the information supplied by the customer. This logic, for example, may be implemented based on an interaction between the Scheduler, the Global Parts system, and the database management system, with the Scheduler being the master system in this case.

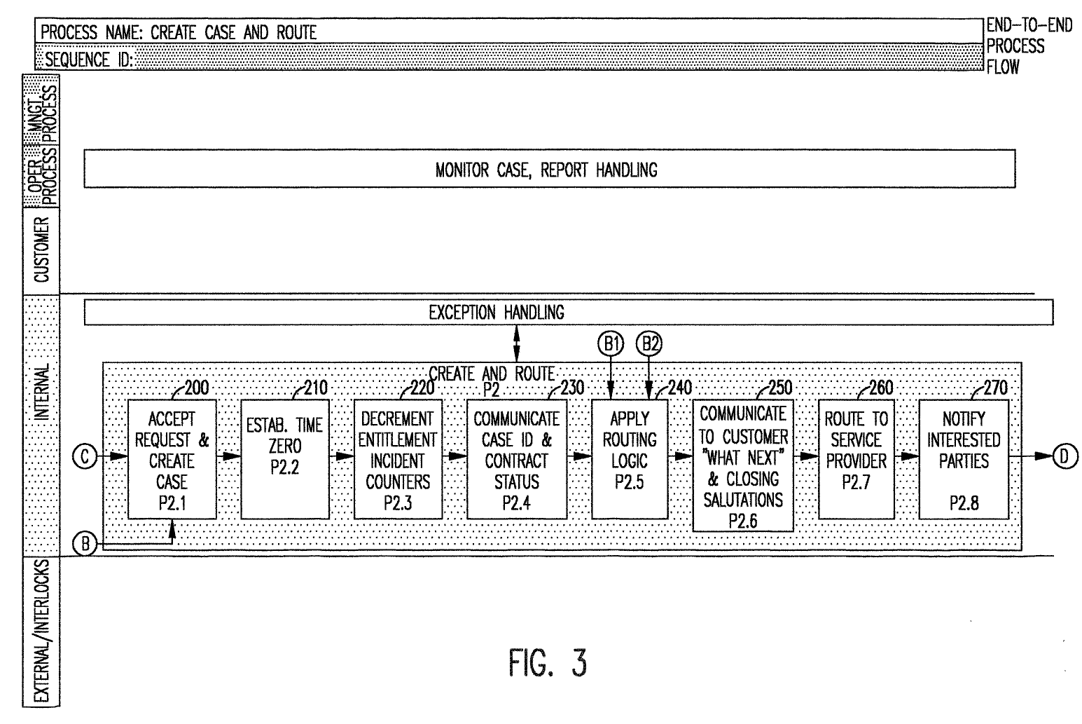

Arrow 60 will be taken when the information supplied is acted upon. For example, the customer supplies an existing service request identification number to the call center representative, and then the request is forwarded by system management to block 240 (FIG. 3) where routing logic is applied to send the request to an appropriate delivery agent. (In FIGS. 2 and 3, the notation “B1” connects the process flow between blocks 53 and 240.) Arrow 61 leads to function block 103 where external business control processes (e.g., parts/logistics, penalty management, contract management, priority algorithms) are performed.

Arrow 62 is taken when the customer has an existing request that he would like acted on. In block 200, the agent would find the existing request, read and understand the request, and then proceed to the next step.

Type of Request/Sub-Request.

If the customer support request is a new request, the type of request is determined in function block 54. Customer support requests may be of several types. An exemplary listing of these requests include:

Broken Machine

Engineering Change

Preventative Maintenance

Repair broken machine

Order Engineering Change

Install Engineering Change

Request missing Engineering Change items

Request Predictive and Preventative Maintenance

Install new machine Move machine

Relocate machine

Upgrade Machine

Install MES

Discontinue Machine

Remove Features

Add features

Add memory

Remove memory

Add options Remove options

Cabling

Inspection of altered machine

PD Assistance only

Assistance to verify correct operation related to external devices

Customer requested standby

Repair transit damage

Inspect for transit damage

Inspect for qualification for IBM Maintenance Services

Documentation update request—error found (No Entitlement Required)

BIOS Upgrade

Missing Ship Group

Presale/Informational

Order Micro code—Need rules of who is authorized to select

Order firmware—Need rules of who is authorized to select

Install firmware

Install micro code

Unknown—Voice only

Requests/sub-request are determined by the call center representative from, for example, dialog with the customer. Selection of a sub-request type may be made in accordance with a pull-down menu listing on the representative's terminal.

Function block 54 is connected to external process function block 104 by an arrow 63. Arrow 63 is taken anytime the manufacturer wants to upgrade an existing product, add a new function to a product that is built inside of the identified external processes (Initial Product Development(IPD) or Initiation Solution Design(ISD), or install an new product (Machine List).

Customer Location.

The location of the customer is determined in function block 55 in accordance with steps that include asking the customer for his or her telephone number, if it is not already provided by the IVR/CTI. If the customer gives the customer number/keyword/contract number or other identifying information, that information is used to perform a database search to determine the customer location. The results of the search are then verified with the customer during a dialog. The customer will then validate this information. If any of the information is incorrect, the call center representative will update the database records using the Scheduler tool to reflect the proper information. If more than one customer location exists, the call center representative will create a new record in the database indicating the proper customer location corresponding to the support request.

Function block 55 is connected to function block 105 along arrow 64.

Function block 105 is an external process interlock and can be multiple databases as identified by the diagram. Arrow 64 is used to link to the databases to locate the correct customer location information using a database look-up.

Through the life cycle of a service request, the progress of a service request is monitored by providing appropriate action (notification or proactive links to the customer satisfaction process. Monitoring also includes tracking of Queue operations, e.g. in terms of measurements. Arrow 65 shows a link between the identify requester step of the invention and the entitlement stage. This arrow shows that entitlement may occur at any point in time throughout the process of the invention when the call center representative has received enough information from the customer and can verify that information in the database (e.g., the existence of a customer service contract that is still in effect).

### Identify Object of Service

Once the identity of the customer has been determined, the object of the customer support request (e.g., whether the request involves hardware or software) is determined. This is performed in accordance with the following sub-process steps:

| Function Block | Function |
|---|---|
| 55 | Identify object of service |
| 56 | Collect product specific data |

Identify Object of Service.

In the preferred embodiment of the invention, the object of the support request involves a problem with computer hardware, software, or both. To determine which product category the support request relates to, the following steps are taken. First, the customer is asked, during dialog with the call agent, for a product number/name, version and/or release. To assist the customer, the agent may access a display screen containing product information which is then conveyed to the customer. If the customer is unable to identify the product number/name, version, and/or release, the call may be terminated to routed to the exception handling stage 25. At this point, if entitlement had been previously determined (e.g., during any of the steps in the Identify Requester function block 32), entitlement verification may be performed, for example, by checking the object of service information against the service contract information stored in the database.

Function block 56 is connected to function block 106 by arrow 66. Arrow 66 is taken to verify that the product is released for service. Block 106 corresponds to an external database that is queried to verify the product is released for service.

Collect Product Specific Data.

Once the object of service is determined, product specific data is collected about the identified object of service to assist in further entitlement decisions and/or to prepare for service delivery criteria. This is hardware only for this entire block.

Sample Set of Product Reference Data:

Country

Description

Model

Type

Logo Description

Serial # Location & Format

Serial Number Required

Manufacturer's Name

Dealer serviced

Service Organization

Call screening Organization

Valid Methods of Service for Life cycles & Default

. . . In-Flight, Warranty, Upgrade, MA, Internal

Early ship Program

General Availability Date

End of General MA

End of Service Date

Billable Service

Hourly Service (Inside & Outside Business Hours)

. . . Rate, Class, Minimum Bill, Units of Bill

Customer Setup Machine

Metered Machine

Preventative Maintenance (PM) Frequency

Warranty Months

Usage values (e.g. for Printers, may change required action like PM in addition to repair)

Penalties types and conditions (i.e. Call Back Time, Total fix time, System down)

Function block 107 is an external database that may be queried to return specific information to block 57.

### Collect Service Delivery Data

Once the object of the service request has been identified, service delivery data is collected in accordance with the following sub-process steps:

| Function Block | Function |
|---|---|
| 70 | Determine location of service |
| 71 | Determine problem description |
| 72 | Determine the severity of the problem |
| 73 | Collect missing service delivery data |

Location of Service.

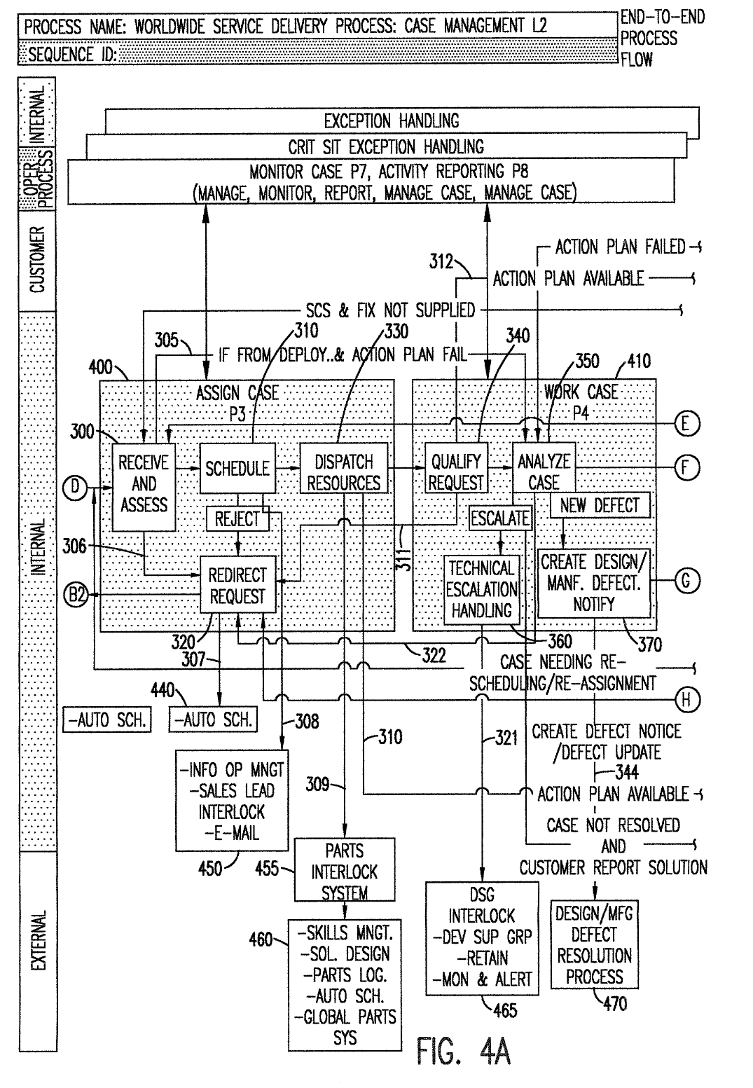

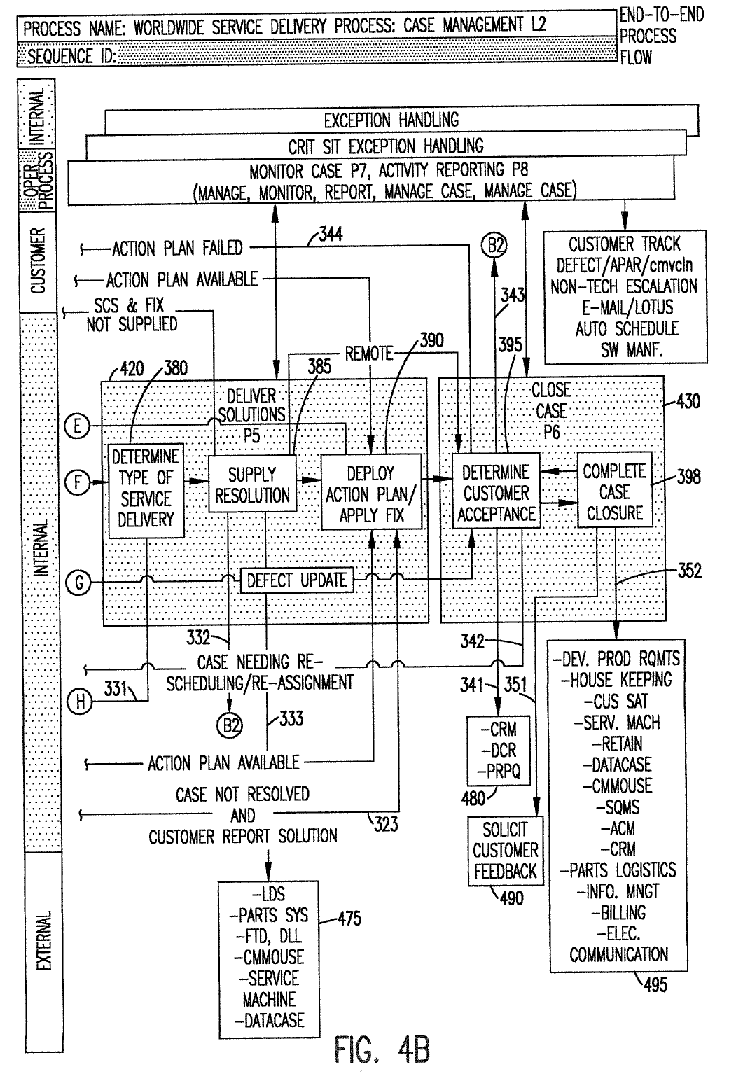

The location where support services are to be provided is determined in accordance with steps that include having the database system prompt the call center representative to ask the customer if the customer location record address is the service delivery address. The representative will then enter into the database system the specific location (e.g., building number, floor number, room number, etc.) of the customer based on his or her response. The management system of the present invention may operate interactively, for example, through the Scheduler tool, to guide the call center representative through the process steps of the invention. The interactive nature of the system of the present invention may not be confined to determining the location of service, but if desired may be extended to other functions of the call center representative as well as the steps taken in FIGS. 3 and 4 to be discussed in greater detail below.

Function block 108 is an external database which is queried to insure that products that are shipped to the customer are going to the customer location. This is a safety check to insure that resources and/or materials are not sent to a wrong place.

Problem Description.

This process will gather details that further describe the customer request. Here, the system will prompt the request taker to ask the customer for a brief description of the request. The request taker will compose an abstract of the request and insert it into an extended description field of the Scheduler tool used for entering records into the database. If the customer describes changes to the object of service or request/sub-request, the system is updated accordingly.

Severity of Problem.

The severity of the problem may be determined by the call center representative, in whole or part, based on the customer's opinion of the problem and/or the manner in which the problem has or will adversely impact the customer's business. Problem severity may be broken down as follows:

Severity 1—Critical business impact. The customer is unable to use the product resulting in a critical impact to their operations. This condition requires immediate solution.

Severity 2—Significant business impact. The customer is able to use the product, but his operations are severely limited by the problem.

Severity 3—Some business impact. The customer is able to use the product with less significant features unavailable. These restrictions, however, do not have a critical impact on operations. General questions like how to, usage, etc. may correspond to a severity of this type.

Severity 4—Minimal business impact. The problem causes little or no impact to the customer's operations, or the customer or branch office representative has implemented a reasonable circumvention. General questions like how to, usage, etc. may correspond to a severity of this type.

Preferably, the system is able to recognize that, from contract-to-contract, the number of values may vary and the definition for each value may be different. This recognition is performed by the database management system. For example, one contract may have 7 values, and another 3 values. One contract may define “major business impact”as 2 hour service delivery, while the other may define “major business impact”as 3 hour service delivery. In accordance with a preferred embodiment of the invention, interaction with the customer including the process of gathering information at all steps in FIG. 2 may be performed interactively by, for example, the system prompting the request taker of what questions to ask. The following is an example of the interactivity that may take place between the system and call center representative in determining problem severity:

Does contract provide customization based on Customer Severity?

Yes: Call center representative asks customer per the dialog and enters appropriate value into the Severity field in the system management tool.

Are Hours of Coverage effected by Severity value? (e.g. 8 am-6 pm, 24×7)

Yes: System management tool modifies the value in the Hours of Coverage fields based on customer-specific CCF

No: No action, continue

Are Days of Week effected by Severity value? (e.g. Mon-Fri to Mon-Sat)

Yes: System management tool will modify the value in the Day of Week fields based on customer-specific CCF

No: No action, continue

If severity is not a required data element of contract, call center representative taker asks customer “What impact does this request have to your business?”. (DIALOG)

System management tool prompts call center representative with the following choices:

| | |
|---|---|
| Severity 1 | [description] |
| Severity 2 | [description] |
| Severity 3 | [description] |
| Severity 4 | [description] |

Request taker enters appropriate value into the severity field of the system management tool

As part of the overall entitlement process, a comparison between the severity of the problem and the type of service in the customer service contract may be made via a database search. If problem severity is not a term of the customer's service contract, then the problem severity step may be omitted.

Collecting Missing Service Delivery Data.

The foregoing steps of the invention will build a free-form narrative information/technical information data. This information is preferably entered in a structured format in order to send to a field device. This process will also gather when the customer wants service. In addition, this process will collect any data elements that the contract needs (i.e. for billing purposes, measurement purpose, etc.). The following is an exemplary list of the types of missing information which may be collected:

Customer requested time of service

Customer requested date of service

Rate quoted indicator

Billable Rates Data Element

Final/Scheduled Service Delivery Data and Time

Customer Problem Number

Vendor Problem Number

After the service delivery data has been collected in function block 34, a determination is made in function block 20 as to whether or not the customer is entitled to have the support request satisfied. This is determined based on a set of criteria may include, for example, any one or more of machine type, machine serial number, customer name, customer number, component identification number, contract number, request type, and sub-request type.

Customers who are not entitled to receive the services requested are routed to the exception handling process in function block 25. The functions performed in block 25 include research as to why the customer is not entitled or the sale of a new contract. If the customer states that they have a contract this research will happen and make the determination as to why the contract management databases are not up to date, insure that they get updated so the failure does not happen again or execute the sale of the contract that the customer wishes to purchase in the event that they do not have a contract.

### Customer Case Creation and Request Routing

If the customer is entitled to have the support request satisfied, the create-and route process shown in FIG. 3 is performed. This process involves the following sub-process steps:

| Function Block | Function |
|---|---|
| 200 | Accept request and create case |
| 210 | Establish “time zero” |
| 220 | Decrement entitlement incident counters |
| 230 | Communicate case ID & contract status |
| 240 | Apply routing logic |
| 250 | Communicate to customer “What Next” & closing |
| | salutations |
| 260 | Route to service provider |
| 270 | Notify interested parties |

Request Acceptance/Case Creation.

Once the entitlement issue is resolved in favor of the customer request, entitlement exception handling makes a decision of whether to accept the case. If the entitlement exception handler accepts the request, a record is created in the system database with a case identification indicator to allow it to be easily accessed by personnel in the management hierarchy. The customer is then informed of the planned actions to be taken and may be given the necessary case information (e.g., case ID, times, units left if an incident based contract, etc.). The planned action is communicated back to the customer preferably by speaking with the customer directly. A request analyzer may perform the customer contact. If during the entitlement determination process, an existing record of the customer exists in the database system, process control is forwarded to function block 200.

Establish Time Zero.

Time zero corresponds to a time when all process measurements begin. This is to ensure that the system builds a customer's view of the process and not randomly selecting a point to measure how good the process is. This time also corresponds to the first identifiable contact with the service delivery process.

Decrement Entitlement Incident Counters.

Counters which measure service/contractual criteria (i.e. response times, fix times, etc.) are started during this process. This pertains, for example, to the case where the customer has purchased a block of hours in his contract. The system decrements this time so that when the time runs out, the customer may be notified of the need to purchase more time. Time decrement begins when the case is accepted because that is the point that the corporation will begin to expend resources on the request.

Communicate Case ID & Contract Status.

In this step, the case ID is communicated over the telephone to the customer/requester. If the call came in electronically, then the case ID would be sent back to the person that submitted the request. Contract status corresponds, for example, to the case where is entitled to next-day service and someone will be on-site by 3 pm tomorrow, or you have two-hour response and some one will be on-site within two hours. This information will also be communicated to the customer/requester.

Apply Routing Logic to Identify a Service Provider.

The case is routed to the appropriate service provider to handle the request based on routing logic within the system. The service providers (or delivery agents) eligible to receive the case may be categorized as follows:

a) Local Delivery Agents (LDA)—Customer Support Representatives (CSRs), Customer Engineers (CEs), and Local Assistance Requests (LARs) contractors.

b) Remote Delivery Agents (RDA)—pre-screening, software support, help desks.

c) Support Delivery Agents (SDA)—escalation specialists, product engineering, field technical support.

The LDAs, RDAs, and SDAs may all play a role in providing services for a particular case. For example, a remote delivery agent may initially contact the customer on the telephone, collect case information, perform preliminary problem assessment and develop an action plan. That individual may then pass the case to the scheduler for assignment to a local delivery agent. The local delivery agent then provides on-site repair services according to the action plan. If the action plan fails, the local delivery agent may then pass the case to a support delivery agent.

Depending on the status of the case and where the case is in the process, LDAs, RDAs, and SDAs may each perform steps within the process cycles of the Analyze Case, Work Case, and Deliver Solution blocks before they pass the case to the next agent.

Communicate to Customer “What Next” & Closing Salutations.

A “What Next” communication notifies the customer that he is being transferred to another person in the process, or that someone in the process is going to call them back by a certain time, or that someone is going to heir location by a certain time. Closing salutations are then communicated to the customer in his native language, e.g., “Have a nice day.”

Route to Service Provider.

Most customer requests will be sent to remote support agents to develop/implement an appropriate action plan. A standard case prioritization methodology ensures the correct priority is assigned to the case for proper queuing/handling. Delivery agents will have queues monitored by queue managers supervisors and the system to ensure that cases needing attention are serviced in the correct order.

The communication method used to transfer the case from entitlement to the delivery agent varies according to the delivery agent. Most remote and support delivery agents have system access and receive their cases in queues or work in progress (WIP) bins, while local delivery agents may use phones, pagers, and special field devices (i.e. RIM, Casio devices) meant to receive radio transmissions with the case information.

The routing logic within the computer management system of the present invention preferably controls how communication may be performed to correctly route the case. Interlocks to the scheduling tools outside of the management system will ensure workload balancing among the local/remote delivery agents. An activity code is sent to the management system to acknowledge receipt of the case by the delivery agent.

Notify Interested Parties.

Interested parties (e.g., marketing reps, field managers, product managers) are notified based on the criteria kept in the customer profile when applicable. The interested parties will be notified automatically via e-mail or pager, or manually via a phone call.

### Service Delivery Process

Once a delivery agent has been identified, a service delivery process as shown in FIG. 4 is performed. The service delivery process is performed in accordance with function blocks which include:

Assigning the case 400

Working on the case 410

Delivering the solution to the customer support request 420

Closing the case 430

### Assigning the Case

The first step in the service delivery process is assigning the case. This step is performed in accordance with the following function blocks:

| Function Block | Function |
|---|---|
| 300 | Receive and assess |
| 310 | Schedule |
| 320 | Re-direct request |
| 330 | Dispatch resources |

Receive and Assess.

Once the case is received, it must be assessed by the delivery agent to determine if the object of service has been sent to the correct place. The qualifications for assessing the case include skills needed, location of service request, tools needed, and possibly delivery agent availability based on the request description and the identified object of service. If the case is accepted by the delivery agent, an activity code is sent by the delivery agent to the computer management system to indicate acceptance of ownership of the case. If the case is rejected by the delivery agent, the case is redirected back to the case owner with a log note explaining the rejection.

The computer management system and queue managers/supervisors monitor cases pending owner acceptance and escalate cases not meeting a predetermined criteria as selected by the corporation. There are 2 types of escalation. One is technical escalation. What this means is that the skills applied to the original request are not solving this request in the time frame that is satisfactory to the customer or the criteria that was set for that product. This will force the request to go back through the process and different skills and resources will be applied to the request to resolve the issue. The second type is a management escalation. This is when management of the resource and process steps in and lines up the appropriate resource skills and materials in the advent the actions taken do not solve the request to the satisfaction of the customer and management.

If the action plan fails to satisfy the customer request, the case may be redirected and reassigned to support or remote delivery agents to further work/analyze the case and develop the correct action plan. See arrows 305 and 306. (Up to this point, flow diagrams 2 and 3 do not show development of an action plan. This is performed during the Work Case process in the function block labeled “Analyze Case,” to be discussed in greater detail below. Arrows 305 and 306 come into play when the original action plan that was created fails to solve the request. Thus, for example, if the customer problem was not correctly identified the first time through the process, a fault existed in the original diagnosis or action plan. Therefore, re-analysis of the problem underlying the customer support request is required.) Ownership of the case may be assigned/transferred to the RDA/SDA when technical escalation is invoked.

Schedule.

The Scheduler tool schedules the resources (e.g., technicians, materials, or both) needed to provide the customer solution. This involves determining, for example, whether there are human resources, materials, and/or labor required, just human resources required, or just materials required to select a service provider based on the type of service entitled. In making this selection, the Scheduler also takes into consideration the availability of the delivery agent (service provider) and the contractual obligations (usually time) needed to deliver the solution. Suitable scheduled resources are then dispatched/notified to execute the action plan and communicate the commitment to the customer (as appropriate). The scheduling of these resources may occur even when a formal action plan has yet to be fully developed, because at times the literal terms of the support request will make evident the need for certain resources.

In selecting a delivery agent and resources, at least the following is taken into consideration: The skills that are available, the people that are available, the location of the people (where in the city are they in) what test equipment is available, where the test equipment is located, what the traffic patterns are for the cities, where the materials (parts location the parts stocking locations).

Arrow 308 will be taken when there is no need to dispatch resources in order to satisfy the customer support request. This may occur, for example, during the steps performed in block 300, where it is determined that in order to resolve the request the customer must purchase something to resolve the request. In block 450, which is a completely different process, a contract may be sold to the customer that will resolve the request. This process is known as up-selling. Dispatch Resources. After the resources have been scheduled, they are dispatched in a timely manner to resolve the customer support request. The dispatched resources may be a technician skilled to perform a specific task and/or materials required to be shipped to the customer location for purposes of resolving the request. The following sub-process steps are exemplary.

First, the appropriate skill for solving the problem would be identified from the database and/or the appropriate materials would be selected from the Global Parts System. Second, the availability of these materials and/or persons who can perform these skills are determined based on the proximity of the customer site. Third, the skilled technicians would be notified via a telephone call, page, e-mail or other means to arrange an exact date for service delivery. (These skilled technicians may be the Local Service Delivery Agents discussed in greater detail below). The materials required would also be shipped to the customer location via courier, FedEx, UPS, or other means. Fourth, information from the database system (e.g., corresponding to the customer record) will be forwarded to the technician to enable service to be made. The technician would then contact the customer to make arrangements for an on-site call, or merely travel to the customer site to satisfy the request.

Arrow 309 is taken when material is required to solve the request. The actions in block 455 locate the identified material closest to the customer. Arrow 310 is taken when a on-site resource is required to solve the request, and block 460 is taken to obtain a skilled technician with appropriate skills as identified from the scheduling and resource dispatching steps and to obtain needed materials via the Global Parts System.

Re-Direct Request.

At times, there is a need to re-direct the customer support request to a different skilled technician, e.g. delivery agent. Arrow 307 is taken when such need arises. The steps performed in block 440 involve the Scheduler locating that other technician based on the different skill required.

Working the Case.

Once a case has been accepted by a delivery agent (depending on what stage of the process the case is in, this may be any of the three types of agents: local, remote, or support) and/or resources dispatched, the agent works the case in accordance with the following steps:

| Function Block | Function |
|---|---|
| 340 | Qualify request |
| 350 | Analyze case |
| 360 | Technical handling escalation |
| 370 | Create design/Manufacturing defect notice |

Qualify Request.

Qualify request functions are performed to determine whether the customer support request has been sent to an appropriate delivery agent. This involves, for example, the agent reading the customer record in the system database corresponding to the customer request and confirming that he or she is qualified (e.g., possesses the skills required) to handle the request. Arrow 311 is taken when the agent determines that he or she is not the correct person to be working on the request. Arrow 312 is taken after the agent has read the entire request and determines that someone else has worked on the request and has already created an action plan. This will cause the agent not to re-perform these steps, thereby saving time and money of the manufacturer and frustration by the customer.

Analyze Case.

This process is performed when no qualified action plan exists, or when a previously formulated action plan failed or was incomplete. In this case, the service provider uses his experience and expertise to create an action plan which satisfies the customer support request. This action plan is preferably documented into the record in the customer support management system corresponding to the case, and includes information corresponding to an identification of the source of the problem and/or a recommended course of action. Action plans are preferably identified by sub-request type and object of service.

In formulating the action plan, cases may be ‘linked’ together for the same or associated objects of service for a customer situation. The output for this activity would be a documented action plan with source of problem identified or a recommended action to take. Local delivery agents performing on site service would develop an action plan as part of the problem determination/problem source identification.

The delivery agent takes into consideration the severity of the problem, the customer environment, the services for which the customer is entitled (determines type of service delivery), and creates an appropriate action plan. If the delivery agent is unable to develop an action plan, it will engage additional assistance from the next higher level of technical support through a “Technical Escalation Handling” process.

If the problem is determined to be a design or manufacturing defect that cannot be resolved through normal technical escalation, the “Create Design /Manufacturing Defect Notification” process will be used to engage engineering resources for problem resolution. Once the action plan has been created, it should be communicated to the customer for acceptance. Remote and support delivery agents document the actions to be taken in the case record and initiate the appropriate service delivery of the solution.

If the action plan fails, an analysis of the case using higher skilled technical resources may be needed. Again the “Analyze case,” “Technical Escalation Handling” process and possibly the “Create Design/Manufacturing Defect Notification” process would be used. If additional resources are needed, the scheduler would organize the resource and dispatch appropriately. Arrow 322 is taken during the analyze steps when there is a need to engage either higher-level technician or a technician with a completely different set of skills than those contemplated in the action plan, so that a new action plan may be developed.

Technical Escalation Handling.

Technical escalation handling is performed under one of three conditions:

1) when a service request owner or delivery agent cannot resolve the problem in a time frame that supports the customer's expectations or no resolution is available to the service request owner or local delivery agent;

2) when the problem duration time is exceeded, in which case technical escalation will be triggered by a monitor service request on committed/contractual time to solution or circumvention exceeded;

3) when customer/delivery agent specifically asks for the next level of support.

In performing technical escalation handling, the call center representative or other system personnel determines the steps that were take in the previous action plan and how they were performed. The representative will then make the determination as to what level skill is required to perform the next action plan.

He will either send a request for assistance to the proper skilled technician to take the next step for the request or assign the request to the correct skilled technician directly.

Function block 360 is connected to function block 465 by arrow 321. Arrow 321 is taken when the call center representative (or other support personnel) determines that a technical escalation must be performed. The determination may have been made that a technical escalation is required in order to resolve the customers request. This particular skill level would go to the developer or engineer that has the best skill to resolve this request.

In function block 465, additional analysis of the customers request is performed, including going through the Analyze Case steps (discussed below) to determine, for example, the type of service delivery required. The resolution steps would then be supplied, or if the resolution could not be determined by this level of skill the process steps for Create Design/Manufacturing Defect function block.

Arrow 323 is taken when the customer finds the solution to the request himself. Under these circumstances, the customer would notify system personnel that a workaround or solution to the request has been found. Steps are then taken to update the system accordingly and, if appropriate, close out the system file corresponding to the request.

Create Design/Manufacturing Defect Notice.

This notice is given when a new defect is suspected in the product. The notice may be in the form of an authorized program analysis report (APAR) or a maintenance tape request (MTR), for example. After the notice is given, process control is forwarded along arrow 344 to an external design/manufacturing defect resolution process in function block 470.

### Delivering the Solution

After the case has been analyzed, the customer support request is solved in accordance with the following function blocks:

| Function Block | Function |
|---|---|
| 380 | Determine type of service delivery |
| 385 | Supply resolution |
| 390 | Deploy action plan/Apply fix |

Type of Service Delivery.

When an action plan has been created and resources have been identified and dispatched for satisfying the customer support request, the manner in which the delivery agent may deliver the action plan is determined. The type of delivery may vary depending upon the solution (e.g., “fix”) and the type of service delivery to which the particular customer is entitled. Hardware/software problems may be fixed by phone, by Local Assistance Request (LAR), by physical media, by local delivery agent replacement of a field replaceable unit (FRU), by the customer replacing a customer replaceable unit (CRU), by sending packing material for service center repair, by electronic APARs, or by any other means that the customer is entitled to receive service.

Function block 380 is connected to function block 320 along arrow 331. Arrow 331 is taken when it is determined that a different skill set is needed to resolve the customer request or that a technician is needed to go on the customer site to resolve the request. Process flow must then continue to function block 440 for automation scheduling of these resources.

Supply Resolution.

After the case has been analyzed and a type of service delivery is determined, the resolution to the customer request is supplied. This differs from the step of deploying the action plan. Specifically, in function block 385 the action plan may be implemented remotely to resolve the request. In contrast, deploying the action plan involves either electronically sending some information to a machine that would require some sort of overt action to be performed in order to deploy the fix or sending a local service delivery agent to the customer site to deploy the fix.

Arrow 333 is taken to function block 475 when external processes and tools are required to create the action plan that would be followed by another agent if the agent who delivered the solution cannot resolve the request, or to otherwise assist in the development of the solution to the customer request.

Arrow 332 is taken when another skill is required to deliver the solution or an on-site resource is required to deploy the action plan. Under these circumstances, process flow is forwarded to apply the routing logic in function block 240 in order to identify a delivery agent with the skills required. Process flow then continues from the routing logic block as previously described. The notation “B2” in FIG. 4 therefore corresponds to a feedback process loop.

Deploy Action Plan/Apply Fix.

After the supply resolution step, the delivery agent performs the action plan, on-site if necessary. After the plan is executed, the delivery agent preferably tests the product to insure that the action plan actually resolved the customer request. The agent would then restore the product to its original condition and process flow proceeds to the next step.

### Closing the Case

After the case has been worked, the case is closed in accordance with the following function blocks:

| Function Block | Function |
|---|---|
| 395 | Determine customer acceptance |
| 398 | Complete case closure |

The above functions may be performed when the following has occurred:

1. notification that a solution has been applied

2. resolution has been provided to the customer contact

3. the solution/fix was delivered to the customer

4. local personnel successfully completed all assigned tasks

5. customer contact/requester indicates that the fix has been successful

6. customer contact/requester requests cancellation of the request

7. time frame defined for task resolution lapses

8. trigger from service request in close pending status or on agreed automatic closure data

9. for sub-cases, completion of the tasks assigned in the sub-case

Determine Customer Acceptance.

To ensure that the action plan deployed by the delivery agent is satisfactory to the customer, the delivery agent may, for example, demonstrate to the customer on-site that the support request was in fact resolved, let the customer test the solution himself, and/or let the customer run the product that was defective or malfunctioning. If the “fix” was remotely applied by the delivery agent, the customer could communicate his acceptance via e-mail, telephone, any other method of communication.

Process flow may continue in several directions from function block 395. Arrow 341 is taken to function block 480 if the customer did not like the resolution of the request and/or needed the original design of the product to be changed. In this block, DCR corresponds to a Design Change Request. The delivery service process is the process that would be used to invoke the design change.

Arrow 342 is taken (1) if the customer was given the solution but then asks the delivery agent or other system personnel to reschedule the application of a fix to a more convenient time, or (2) when there is a need to reassign the resources to resolve the request.

Arrow 343 is taken only when there is a need to apply a different resource to the request, and the request needs to be routed to another delivery agent/technician to request resolution. Under these circumstances, process control is fed back to function block 240 in FIG. 3. Arrow 344 is taken when the customer has indicated that the action plan deployed by the delivery agent to fix the problem is unsatisfactory. Under these conditions, process flow is fed back to function block 350 for additional case analysis.

Complete Case Closure.

Once the solution is accepted, the case owner can close the case even though there may be some administrative actions, such as returning parts, that have not yet been completed.

If the solution provided by the delivery agent does not resolve the problem to the customer's satisfaction, process control is fed back to the “Working the Case” function block where the delivery agent performs further case analysis or invokes technical support to provide an improved solution to the problem. The delivery agent will manage the dissatisfaction or, if appropriate, invoke an escalation process (i.e. customer care, duty manager, etc.) to receive assistance. Service centers assume customer satisfaction when they sign the receipt for the machine. Customer satisfaction surveys and knowledge base updates are triggered (if applicable) when the case is closed.

The status of the case is kept updated by the delivery agent to reflect the latest activity. Activity codes indicating that the delivery agent is or has: called the customer, traveling to service location, on site, hold for parts, mailed packing materials, received at service center, etc. (an entire list of status and activity codes have been developed and agreed to globally and will be used throughout the entire process) are collected by the system and available for case owners to monitor the progress of the case. Activity reporting changes the status of the case and may trigger events in the monitor case process to automatically take place such as raising alerts when contractual obligations or service delivery commitments are about to be missed.

Arrows 351 and 352 advance control flow to function blocks 490 and 495, respectively. In block 490, the delivery agent would survey the customer to determine, for example, how service could have been better provided and what additional improvements could be made in the future. This information would then be used to In block 495, the agent performs a general clean-up of his or her work area, fills out required paper work, updates the system database to reflect that service has been provided, updates customer help desks and other tools to indicate that the customer request has been satisfied and may be closed out. Roles and Responsibilities of System Personnel

Call Center Representative:

The call center representative receives customer support requests and performs initial call management. For calls from in-house personnel, customers or business partners of the manufacturer, this representative obtains from the customer initial information (e.g., product identification information, a brief description of the support need, etc.) and enters this information into a Call Management system record (case) stored in the system database. This agent also ensures that the requester is entitled to service, assigns an initial degree of urgency for request handling, and transfers the request to the appropriate queue. (Handover to the role of Remote Service Delivery Agent.) Preferably, the call center representative is a person with skills in remote call management and telephone customer relations.

Remote Service Delivery Agent

The remote service delivery agent is the first technical specialist who talks to the customer. These agents must be able to communicate in the correct national language, technical/product language, industry language, e.g., Computer-Graphics Aided Three-Dimensional-Interactive Application (CATIA) users vocabulary. Also, it is preferred that these agents have system-wide experience and knowledge with respect to the product line(s) (e.g., hardware and software) of the manufacturer so that he/she can perform complex problem determination and problem source identification. In order to perform these functions, this agent should be a highly skilled technical professional, such as a systems service representative, a systems software specialist, or an IT specialist.

After speaking with the customer, remote service delivery agents will technically qualify the customer support request according to all information provided by the customer, enriched by all replies to the relevant questions they have asked. They will then perform thorough investigations of the problem underlying the request using personal technical knowledge and/or any one or more of the databases and available technical documentation to find known corrections, bypasses or technical advice. The customer may then be informed of this information as a preliminary step toward problem resolution.

Scheduler.

The scheduler is responsible for managing execution of the action plan (defined by technical tasks) when requested by the remote service delivery agent. Schedulers organize and optimize scheduled tasks for each customer support provider according to required skills and geographical locations. They order and manage parts and handle communication with customers prior to local service delivery agent involvement. They also manage hardware request closure. Skillwise, schedulers should be field professionals who have experience in administrating territory customer operations.

Local Service Delivery Agent.

The local service delivery agent delivers on-site hardware support and services and executes the action plan as defined by the Technical Call Qualifier. This agent completes the on-site support action, informs the customer of the final solution, provides the scheduler with feedback when the action plan is completed, and initiates closure of the request. Local service delivery agents are preferably hardware technicians with skills in the customer's technical environment.

Hardware Technical Support Specialist.

Hardware technical support specialists provide the highest level of support on products for which they are specialized. They perform remote or/and on-site support work with worldwide support structure when required, and populate the international databases and machine month (MM) information systems with the experience learned from the escalated repair action.

Software Technical Support Specialist.

The software technical support specialist executes the action plan as defined by the remote service delivery agent for software-related support requests, and performs in-depth investigations by use of technical material provided by the customer or problem re-creation when feasible (applying his product knowledge). When the problem is potentially identified to be an unknown error in product code (“defect”), this agent escalates the support request to an even more technical person according to the international support structure and the critical situation management process. This agent also keeps the customer regularly informed on the progress of the problem handling. Preferably, the software technical support specialist is a systems software specialist or an IT specialist who specializes on software products of the manufacturer.

Processing of a customer support request may include activity reporting by the aforementioned agents at various stages of process. By updating the customer-support database system of the invention with activity reports at each process level, management of the customer request may be monitored by key personnel at each stage of completion. These activity reports may include:

1. scheduling time of reporting (monthly, weekly, daily, per event, etc.)

2. Ad hoc/on demand

3. activity reporting-must be able to capture off-terminal time

4. reporting any activity performed in connection with a service request

5. reporting change of service request ownership

6. change of status of a resource

7. activities are outside of a defined range of target established.

8. schedule/diary is updated

9. For “Block of Time” contracts, automatically decrementing available time to the customer

10. customers accrued billable time request for a report

11. penalties management

In order to measure the effectiveness and efficiency of the system and method of the present invention, quality control may be performed by analyzing process measurements which include:

response time met

repair time met

service request duration

customer escalation

backlog management

open service request age

solution given count

solution given days

call screening effectiveness

efficiency

first time fix (in process)

employee utilization

parts utilization

labor cost per service request

parts cost per service request

total cost per service request

workload plan to headcount

skills certification and GAP

analysis

parts accounting

Quality control may also be determined by analyzing the productivity of the system personnel used to implement the process. This determination may be made by analyzing the productivity parameters including, for example, billable utilization percentage, mean time to repair, call screening effectiveness, and first trip fix.

### Activity Reporting/Status Monitoring

In accordance with a preferred embodiment of the present invention, system personnel will, at each stage, generate and store reports in the database corresponding to each customer support request. Through these reports, any person having access to the system can monitor the status of a support request in real time, irrespective of geographical location. Monitoring may be proactive, meaning that system personnel may, for example, establish links to customer satisfaction processes (e.g., critical situation processes, trailer surveys), make annotations to customer service records, develop alternative actions plans, track queue operations.

The following is an example of how activity reporting and status monitoring may be performed in accordance with the present invention.

According to this example, there are three events which trigger monitoring a service request: Time Triggers, Counter Triggers, and Event Triggers. These triggers are set automatically by system management tools, or are set by authorized remote delivery agents. Automatic triggers are changeable at various levels including user queue level. When a system modification is made, an incidence log corresponding to a relevant customer record or customer support request is created reflecting the data, time, identification, and field changed. The system may then inform the request analyzer (e.g., the remote delivery agent), queue manager, interested parties, of the recent modification.

The system may also have customer contact triggers for generating an activity reports to meet customer-specific requirements. A customer contact trigger may correspond to an alert to call a customer back and/or to notify the customer via an electronic response. The system may be configured to keep track of the number of contacts made and whether or not a response was ever received from the customer in connection with that contact. The system may also track remaining time left on a customer's service contract and alert system personnel periodically prior to contract expiration.

To serve the customer in the most efficient manner, the system may be configured to either automatically generate an activity report to the customer or to alert system personal that enough time has passed or an event has occurred that warrants customer notification. Timewise, internal system counters may be set (e.g., days, hours, etc.) to define a period within which the support request is to be resolved. A record may also be established to keep track of how many service calls were made by delivery agents and the time spent on each call. If the time spent exceeds a predetermined threshold, for example, correlated to the customer's problem severity, system personnel may be automatically notified that a technical escalation is required. The customer may then be notified accordingly.

In accordance with another aspect of the invention, the system may be configured to notify the customer of the status of support request as often as the customer desires, e.g., on a daily basis, weekly basis, before a set date, etc. If the customer does not specify the frequency of when he would like to be notified of the status of his request, a set of default status communication values may be used such as follows:

| | Severity 1 | Severity 2 | Severity 3/4 |
|---|---|---|---|
| Status Communication | every day | every 5 days | every 10 days |

The following information may also be included in the status monitoring/report generation functions of the invention:

Solution given (event)

Solution failed (event)

Solution confirmed (event)

Time to repair (Timer)

Time from dispatch to on-site arrival (Timer)

Waiting for parts

Waiting for courier (i.e. meet with ATM courier)

Parts on backorder (Event)

Waiting on customer action

Service request age is a data field, the Commitment is “hours/days to fix”

Automatically set for all Premium Services Advanced Support customers from resolution time in customer Terms&Conditions

Automatically set for all Premium Services Account Advocate customers only notify if SERVICE REQUEST hits top-40 report

The service request age must be observed for all service requests and queues (e.g. for Backlog).

The following queue operation triggers may be used for status monitoring/reporting generation in accordance with the present invention:

Number of service requests on a queue (Counter)

Number of service requests exceeded Responsiveness on a Queue

Number of service requests exceeded Response Time on a Queue

Number of Service requests exceeded Problem Duration on a Queue

Number of ‘LONG CALLS’ on a Queue

Average Service request Age greater than ‘xx Committed Problem Duration’ on a Queue

Number of Service requests NOT First Time Fixed on a Queue

Penalties raised

Number of queue bounces (3).

Number of owner bounces (3).

Time between queue arrival and owner assignment, set by geography level authority.

Time between queue arrival and customer contact, set by geography level authority

Time between service request creation and customer contact, set by geography level authority

Service request age summed for all service requests for a customer (measurement). Should be used as input to customer

Multiple service requests open for one customer at a single service provider (maybe product or queue. Input to customer

Waiting customer approval to repair as billable

The system of the present invention may also have telephony triggers, such as ones corresponding to CTI hooks and an indication that the customer has been on hold too long. Other system triggers include:

Escalation Triggers

Complaint received

Implementation Statement: turn on radio button when complaint received dispatcher, duty manager, request queue coordinator, Delivery Agent

Service request escalation (service request ownership changes)

Service request escalation (technical delivery agent/action plan change)

Service request escalation (prior to ownership change)

Customer dissatisfied: turn on a radio button that allows a flag to be set that indicates customer has lodged a complaint during the handling of his support request

Skilled resource is not available or existing

Schedule/Dispatch Triggers

Resource availability

Communications to Delivery Agent or external interlock i.e. global parts logistics (paging, MIG, phone)

Scheduler availability

Re-schedule—Trigger every time we reschedule service request for either parts or people

Inability of scheduler to assign resources to a service delivery requirement

Inability to provide specific skilled resource

Inability to meet ETA or CAT (Committed Arrival Time of parts)

Business Rules/Triggers from Remotely Delivered Services

Enable support request status indicators to change as thresholds are exceeded.

Notify current Queue Monitor/Supervisor when contractual commitment involving penalties are not going to be met.

Notify Queue Monitor/Supervisor when there is a support request backlog (number of service requests in queue>queue limit).

Notify Work Group Supervisor when there is a WIPbin backlog (number of service requests in WIPbin>work group limit)

Notify new Service request Owner and Work Group Supervisor when a high severity service request is assigned to a Delivery Agent.

Notify current Queue Monitor/Supervisor when a service request with high severity has been routed to the queue.

Notify current Queue Monitor/Supervisor when a service request routed to the queue has been transferred “X” times. (SWG Team)

Notify current Queue Monitor/Supervisor when any service request with high severity have been routed to the queue at the end of the shift.

Local management will set any restrictions on number of WIP bins that can be assigned to a Delivery Agent

Various other activities may form the basis of a system trigger, such as data changes in the database. The following is exemplary:

1. Owner Change: support request updated by someone other than current support request owner.

2. Support Request is Terminated or Modified (inform the former owner):

Object of Service change

Start to Work service request ‘go’ button

Entitlement changes

Stop (need to define)

Severity change

Automatically inform interested parties list if support request goes to SEV1

Penalties management

Time change request by customer for callback

3. Unqualified service request (e.g. product is not listed in supported product list)

4. Service request is routed back to Receive Request-Route-Entitle process because it is not qualified (Counter)

5. Number of Service requests ‘not qualified’ for a Queue, Platform or

Country/Region Shift Change Customer Satisfaction history—This looks at the number of escalations to take a proactive approach at determining if a customer might go CRITSIT prior to this happening.

6. Time worked on the Service request, escalation criteria exceed

Internal system reports may be generated to detail the following:

Parts/Logistics (transport/courier)

Parts availability

Courier availability

Transport availability

Tool/Test equipment availability

In summary, the present invention is a fully integrated customer support management system and method which is implemented using a single business model to resolve both hardware and software support requests. Through interaction between the system management tools and system personnel, support may be provided to customers both locally and abroad, and in accordance with the preferred embodiment worldwide, in the particular language of the customer. Moreover, through the chain of command established by the system hierarchy, the invention providew the customer with qualified technical assistance within a time period dictated by the customer himself. If this technical assistance provides inadequate, a technical escalation process is implemented as a back-up measure to alert higher level technicians of the customer's problem. And, through the report generation and monitoring features of the invention, the customer is kept informed of the status of his request at all times to thereby meet any and all customer expectations.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

We claim:

1. A method of managing a customer support for both hardware and software products, said method comprising:
providing an automated scheduling software tool connected to a database, said database storing at least one of customer information, product information, service provider information, and routing information;
sending a customer support request to a manufacturer of hardware and software products;
creating a record in the database corresponding to the customer support request using said automated scheduling tool;
routing information corresponding to the customer support request to a remote service delivery agent for development of an action plan to resolve the customer support request, said remote service delivery agent developing said action plan based on said record; and
selecting a local service delivery agent having skills for handling said customer support request, said local service delivery agent being local to said customer and implementing said action plan based on information contained in said record.

2. The method of claim 1, further comprising:
receiving the customer support request by voice or electronically;
determining a language of said customer; and
automatically forwarding the customer support request to a call center representative of said manufacturer who speaks the language of said customer.

3. The method of claim 1, wherein the customer support request is sent with customer identification information, and wherein the language of said customer is determined automatically by comparing said customer identification information with customer information in said database.

4. The method of claim 1, wherein said sending step includes sending the customer support request electronically, by voice, or by mail.

5. The method of claim 1, further comprising:
determining whether the customer is entitled to have the customer support request satisfied, said determining step being performed based on said customer information in said database.

6. The method of claim 1, further comprising:
performing a technical escalation process to develop a different or improved action plan when said action plan implemented by said local service delivery agent failed or when said remote service delivery agent determines that additional expertise is required.

7. The method of claim 1, wherein said customer is located in one country and said manufacturer is located in another country.

8. The method of claim 1, further comprising:
updating said record at each of said routing and selecting steps.

9. The method of claim 1, further comprising:
determining real-time status of the customer support request by monitoring said record in said database.

10. The method of claim 1, further comprising:
transmitting a notification for storage in said database when a problem addressed by said action plan is determined to be new design/manufacturing defect.

11. The method of claim 1, further comprising:
determining whether said customer is satisfied with the action plan implement ed by the local service delivery agent; and
routing information corresponding to the customer support request to a higher-level remote service delivery agent for development of an improved action plan to resolve the customer support request.

12. The method of claim 1, wherein said routing step is automatically performed by a routing logic software tool, said routing logic software tool selecting said remote service delivery provider based on service provider information stored in said database.

13. The method of claim 1, wherein said automated scheduling software tool automatically tracks time delays in answering said customer support request.

14. The method of claim 1, further comprising:
sending electronic alerts to provide notification of delays in implementation of said action plan.

15. The method of claim 1, wherein said record is standardized to contain data fields which are applicable to both hardware and software support requests.
